(19) United States
(12) Patent Application Publication
(10) Pub. No.: US 2010/0003010 A1
(43) Pub. Date: Jan. 7, 2010

(54) IMAGING APPARATUS AND METHOD TO CONTROL THE SAME

(75) Inventor: In Ho KIM, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/472,569

(22) Filed: May 27, 2009

(30) Foreign Application Priority Data
Jun. 17, 2008 (KR) 2008-57087

(51) Int. Cl. H04N 5/765

(52) U.S. Cl. 386/95; 386/117; 386/E05.002

(57) ABSTRACT

An imaging apparatus and a method to control the same are provided. When a captured image is recorded (or stored), a category of the image is obtained according to a feature of the image, and a file of the image assigned a file name determined based on the category is created and stored, thereby enabling more convenient classification of a large number of images. To accomplish this, the method to control an imaging apparatus includes obtaining an image and recording the image assigned a file name determined based on a category of the image.

### CROSS-REFERENCE TO RELATED APPLICATIONS

This application claims priority under 35 U.S.C. § 119(a) to Korean Patent Application No. 2008-0057087, filed on Jun. 17, 2008 in the Korean Intellectual Property Office, the disclosure of which is incorporated herein by reference.

### BACKGROUND

1. Field of the Invention

The present general inventive concept relates to an imaging apparatus and a method to control the same, and more particularly, to an imaging apparatus, such as a digital camera or a digital camcorder that captures and records (or stores) images in a file format, and a method to control the same.

2. Description of the Related Art

Digital image capture apparatuses, such as digital cameras or digital camcorders, have become generalized and widely used along with the development of image capture technologies and digital image signal processing technologies. The number of images captured through digital image capture apparatuses has rapidly increased since digital image capture apparatuses that use storage devices with relatively large storage capacity are little restricted by the capacity of storage for recording captured images, unlike classical analog image capture apparatuses. Users typically classify and store captured images by events. In some cases, users output such images online or offline.

However, as the number of images has significantly increased, it is increasingly difficult for users to classify and manage images based upon events. Accordingly, technologies to automatically classify images have been suggested. When users classify images on their own, they generally classify the images by categories such as time or event. Thus, it is not easy for users to accurately express features of images to be searched for using such categories.

A technology to classify images based on the date and time when the images were captured has also been suggested. For example, this technology uses an image classification method in which images are classified by date using time information assigned to the images to allow users to view the images in a calendar format. However, since this conventional technology classifies images simply by date, the technology has a problem in that images that were captured at the same date are all classified into a single group even though the images have different characteristics such that they can be classified into different groups, for example when the images include images that were captured at home and images that were captured in the office at the same date.

In addition, it takes a very long time for the user to search for images containing a specific feature desired by the user in a large number of images since they have to check all images one by one.

### SUMMARY

The present general inventive concept provides an imaging apparatus and a method of controlling the same, wherein, when a captured image is recorded (or stored), a category of the image is obtained according to a feature of the image, and a file of the image assigned a file name determined based on the category is created and stored, thereby enabling more convenient classification of a large number of images.

Additional features and/or utilities of the present general inventive concept will be set forth in part in the description which follows and, in part, will be obvious from the description, or may be learned by practice of the present general inventive concept.

Exemplary embodiments of the present general inventive concept may be achieved by providing a method of controlling an imaging apparatus, the method including obtaining an image, and recording the image and assigning a file name determined based on a category of the image.

The method may further include generating, when the image is recorded, a directory assigned a directory name determined based on the category of the image, and recording a file of the image in the directory.

The file name and the directory name may be determined to be associated with each other through the category.

The method may further include receiving a category, and wherein the recording the image and assigning a file name is determined based on the received category.

The category may be obtained by selecting at least one category corresponding to the image from among a plurality of preset categories.

The category may be obtained by arbitrarily determining a category based on a feature of the image so that the determined category represents the image.

The category may be obtained by extracting a feature of the image using a predetermined algorithm and selecting at least one category corresponding to the extracted feature from among a plurality of preset categories.

Receiving the category may include displaying a user interface to provide guidance for selection of the category and allowing a user to select the category as a target category through the user interface.

The method may further include selecting and reproducing, when a command to reproduce files corresponding to a target category is issued, images assigned a file name corresponding to the target category from among recorded images.

The target category may be determined by selecting at least one category corresponding to the image from among a plurality of preset categories.

The target category may be obtained by determining a target category based on a feature of the image so that the determined target category represents the image.

The method may further include displaying a user interface to provide guidance for selection of the target category, and receiving selection of the target category through the user interface.

Exemplary embodiments of the present general inventive concept may also be achieved by providing an imaging apparatus including an imaging unit to obtain an image, a storage unit to record the image, and a controller to record the image and to assign a file name determined based on a category of the image in the storage unit.

The controller may perform a control operation to generate a directory whose name is determined based on the category of the image and to record a file of the image in the generated directory.

The controller may determine the file name and the directory name to be associated with each other through the category.

The imaging apparatus may further include an input unit to input a category, and wherein the controller receives the category input through the input unit.

The input unit may be a user interface displayed to provide guidance for selection of the category.

The imaging apparatus may further include a display unit, wherein the user interface is displayed on the display unit.

Exemplary embodiments of the present general inventive concept may also be achieved by providing a computer-readable medium having executable code stored thereon to perform a method of controlling an imaging apparatus, the method including obtaining an image, and recording the image and assigning a file name determined based on a category of the image.

Exemplary embodiments of the present general inventive concept may also be achieved by providing a method of controlling an imaging apparatus, the method including selecting a category, capturing an image, and assigning a file name of the selected category and recording the captured image according to the file name.

Exemplary embodiments of the present general inventive concept may also be achieved by providing an imaging apparatus, including a memory unit, an imaging unit to capture an image, and a controller to select a category and assign a file name corresponding to the category, and to store the image in the memory unit according to the category.

### BRIEF DESCRIPTION OF THE DRAWINGS

These and/or other features and utilities of the present general inventive concept will become apparent and more readily appreciated from the following description of certain exemplary embodiments, taken in conjunction with the accompanying drawings of which:

FIG. 1 illustrates an imaging apparatus according to an exemplary embodiment of the present general inventive concept;

FIG. 2 illustrates a system to control the imaging apparatus illustrated in FIG. 1;

FIG. 3 illustrates a directory structure of the imaging apparatus according to an exemplary embodiment of the present general inventive concept;

FIGS. 4A and 4B illustrate user interface screens to select a category according to exemplary embodiment of the present general inventive concept;

FIGS. 5A and 5B illustrate user interface screens to input a category according to an exemplary embodiment of the present general inventive concept;

FIG. 6 illustrates the concept that specific images can be selected through selection of a category according to an exemplary embodiment of the present general inventive concept;

FIG. 7 illustrates a method of controlling an imaging apparatus according to an exemplary embodiment of the present general inventive concept;

FIG. 8 illustrates a method of controlling an imaging apparatus according to another exemplary embodiment of the present general inventive concept;

FIG. 9 illustrates a method of controlling an imaging apparatus according to another exemplary embodiment of the present general inventive concept;

FIG. 10 illustrates a method of controlling an imaging apparatus according to another exemplary embodiment of the present general inventive concept;

FIG. 11 illustrates a method of controlling an imaging apparatus according to another exemplary embodiment of the present general inventive concept; and

FIG. 12 illustrates a method of controlling an imaging apparatus according to another exemplary embodiment of the present general inventive concept.

### DETAILED DESCRIPTION OF THE EMBODIMENTS

Reference will now be made in detail to exemplary embodiments of the present general inventive concept, examples of which are illustrated in the accompanying drawings, wherein like reference numerals refer to the like elements throughout. The exemplary embodiments are described below to explain the present general inventive concept by referring to the figures.

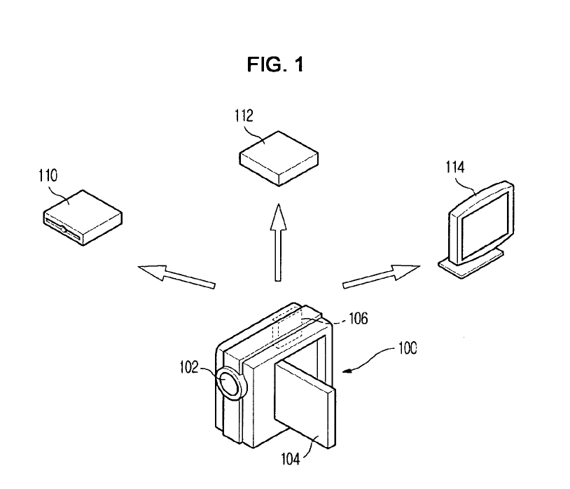

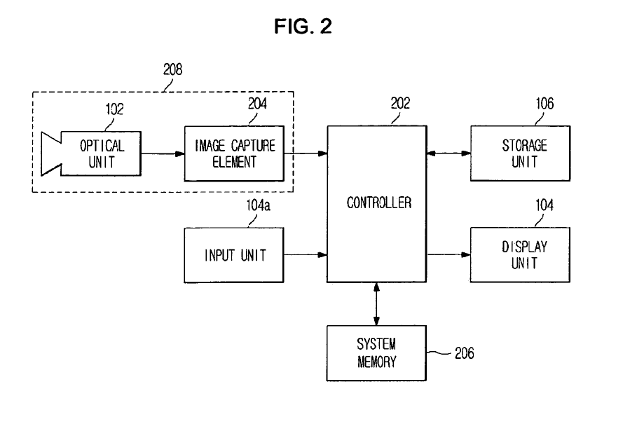

FIG. 1 illustrates an imaging apparatus according to exemplary embodiments of the present general inventive concept. In FIG. 1, a camcorder 100 is illustrated as an example of the imaging apparatus. The camcorder 100, which is a device to capture moving images (and which may also be capable of capturing still images), includes an optical unit 102 and a display unit 104. The optical unit 102 includes a lens and a lens drive system. Light incident through the optical unit 102 is converted into an electrical signal through an image capture element 204 (such as a CCD or CMOS) (see FIG. 2) in the camcorder 100 and the electrical signal is then transferred to a controller 202 (for example, a DSP) (see FIG. 2). The display unit 104 can display a captured image or can display a menu or the like for manual operation of the camcorder 100, and can support a touch screen to receive inputs.

The captured image is recorded in a storage unit 106 that can be inserted in the camcorder 100 and is electrically connected to the controller 202. Storage unit 202 can also be installed within the camcorder 100 and connectable to external devices through an interface such as, for example, a universal serial bus (USB) or an IEEE 1394 interface. Examples of the storage unit 106 used in the digital camcorder include a hard disk drive, a memory card, an optical disc, and a magnetic tape.

Images captured by the camcorder 100 and stored in the storage unit 106 may also be copied to and stored in an external storage, such as an optical disc drive 110 or a hard disk drive 112. The image can be stored in the storage unit 106 and then transmitted to the external storage through terminals formed on the camcorder 100 and the external storage through a communication line between the terminals. The stored images may also be displayed on a TV (or a PC) monitor 114 through a playback function of the camcorder 100. The TV or monitor 114 can be connected to the camcorder 100 through terminals formed on the camcorder 100 and the monitor 114 and a communication line connected between the terminals.

FIG. 2 illustrates a system to control the imaging apparatus illustrated in FIG. 1. As illustrated in FIG. 2, an image capture element 204 is electrically connected to an input of a controller 202. Through the image capture element 204, light incident through the optical unit 102 is converted into an electrical signal and the electrical signal is then input to the controller 202. The optical unit 102 and the image capture element 204 can be combined as an imaging unit 208 to obtain images. A controller 202 that performs image signal processing may also be incorporated into the imaging unit 208 as needed.

An input unit 104a may also be connected to an input of the controller 202. The input unit 104a can be a user interface displayed on the display unit 104 that can be a touch screen or other touch sensitive display. When the display unit 104 is a touch screen, the input unit 104a may be implemented in the display unit 104 so that a user inputs signals therethrough. A plurality of buttons provided on a body of the camcorder 100 can also be included in the input unit 104a. The controller 202 controls the overall operation of the camcorder 100. System software to accomplish this is stored in a system memory 206. Also illustrated in FIG. 2 are the display unit 104 and the storage unit 106, which are described above with reference to FIG. 1.

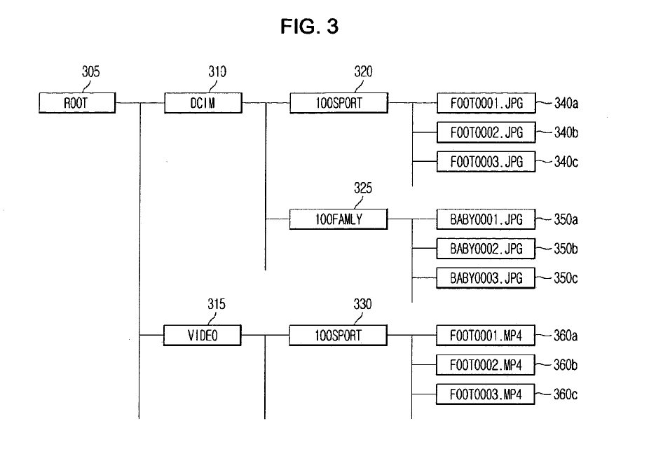

FIG. 3 illustrates a directory structure of the imaging apparatus according to an exemplary embodiment of the present general inventive concept. In the imaging apparatus according to an exemplary embodiment of the present general inventive concept, when an image is recorded, a file, to which a file name determined based on a preset file category is assigned, is created and the image is then recorded in the storage unit 106. As illustrated in FIG. 3, images recorded in the storage unit 106 can be stored in directories created according to a predetermined hierarchical directory structure. A still image directory DCIM 310 that can store still image files and a moving image directory VIDEO 315 that can store moving image files are provided below a root directory ROOT 305.

When the image is captured through the image capture element 204, the image can be stored with information on the directory structure according to the directory structure set before or after the image is captured. Also, a file name can be given to the image when the image is captured and stored according to the directory structure set before or after the image is captured.

User directories, the names of which are determined according to selection (or input) of a category according to an exemplary embodiment of the present general inventive concept, are provided below the still image directory DCIM 310. For example, “100SPORT” 320 and “100FAMLY” 330 in FIG. 3 represent user directories below the still image directory DCIM 310. Photograph files corresponding to respective categories of “sports” and “family” of the directories 100SPORT 320 and 100FAMLY 330 can be stored in the user directories 100SPORT and 100FAMLY. For example, football game photographs FOOT0001.JPG FOOT0002.JPG, and FOOT0003.JPG (340a, b, c) taken with a category of “sports” being selected (or input) are stored in a sports directory 100SPORT 320 whose category is “sports”. If a baseball game scene is captured and sports is selected (or input) as a category of the captured baseball game scene, the captured baseball game photographs are stored in the sports directory (100SPORT 320). On the other hand, photographs BABY0001.JPG BABY0002.JPG, and BABY0003.JPG (350a, b, c) taken with a category of “family” being set are stored in a family directory 100FAMLY 325 which is another user directory whose category is “family”.

Similarly, user directories, the names of which are determined according to selection (or input) of a category according to an exemplary embodiment of the present general inventive concept, can also be provided below the moving image directory VIDEO 315. “100SPORT” 330 in FIG. 3 represents a user directory below the moving image directory VIDEO 315. Moving image files FOOT0001.MP4, FOOT0002.MP4, and FOOT0003.MP4 (360a, b, c) corresponding to a category of “sports” can be stored in the user directory 100SPORT 330.

As illustrated in FIG. 3, file names of sports photograph files and sports moving image files stored in the user directory 100SPORT 320 and 100SPORT 330, respectively, whose category is “sports” are also determined according to the category according to an exemplary embodiment of the present general inventive concept. For example, if “sports” is selected as a category from among a plurality of categories and football (FOOT) is selected (or input) as a subcategory from among a variety of sports games, a head word “FOOT” indicating the football is inserted in a file name of every captured moving image or photograph and such generated files are stored in the sports directory 100SPORT until the category is changed. The file name can include, for example, a total of 8 characters, the first four characters being four Roman letters indicating the category and the other four characters being four digits forming a serial number. The file name of each photograph or moving image stored in the file directory 100FAMLY 325 can also be determined to have a head word “BABY” (for example, files 350a, b, c) indicating the baby that is one of a variety of subcategories.

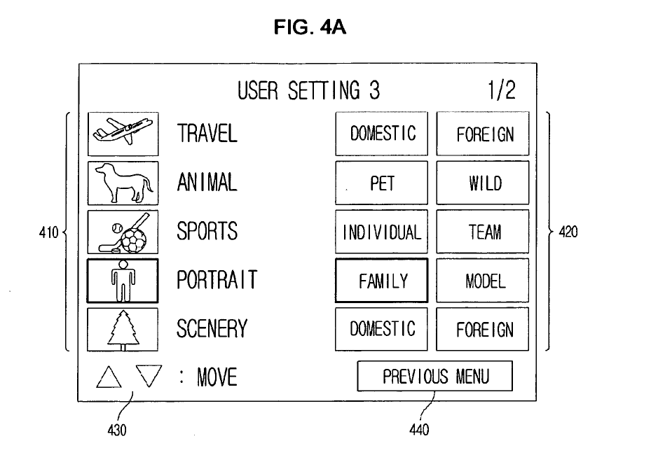

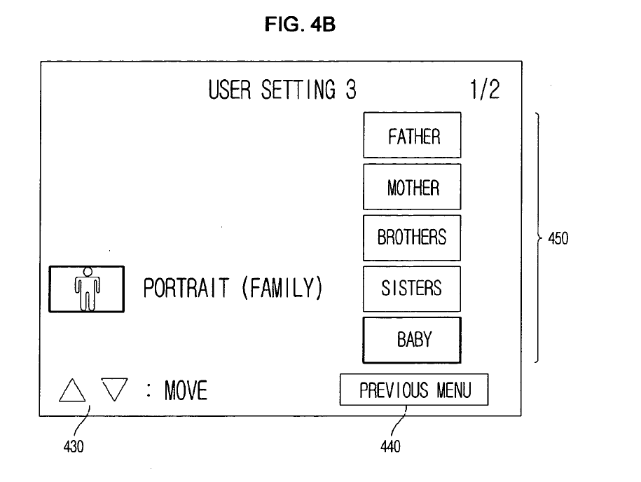

A user may select categories and subcategories through a user interface. FIGS. 4A and 4B illustrate user interface screens for selecting a category according to an exemplary embodiment of the present general inventive concept. The user interface may be generated or displayed before or after the image is captured and stored. These user interface screens can be commonly used to generate a directory and to generate a file. As illustrated in FIG. 4A, a first screen for category selection can display broad categories 410 such as travel, animal, sports, portrait, and scenery, and subcategories 420 of a selected category 410. Subcategories 420 may themselves also include further subcategories. For example, if a the user selects the category “portrait” from among categories 410, and then selects “family” from among the subcategories 420, such as “family” and “model,” of the category “portrait”, the user interface screen can be switched to that illustrated in FIG. 4B to display additional subcategories of the category “family”. The user interface illustrated in FIG. 4B displays the subcategories 450 such as “baby,” “father,” and “mother” of the category “family”. If the user selects “baby” as a desired subcategory from among the displayed subcategories 450, “baby” is determined to be a final category selected by the user and, thereafter, when captured photographs or moving images are recorded, a head word “baby” can be inserted into a file name of each corresponding file. This category and subcategory selection method can be applied to both the selection of a category of a directory and the selection of a category of a file. As illustrated in FIG. 4A, any number of categories 410 can be displayed, and a user may scroll through choices of categories using, for example, arrows 430. Alternatively, a user may view other choices of categories 410 and subcategories 420 and 450, and may make a selection using, for example, a touch screen or buttons of input unit 140a. A user may return to a previous screen by selecting previous menu option 440.

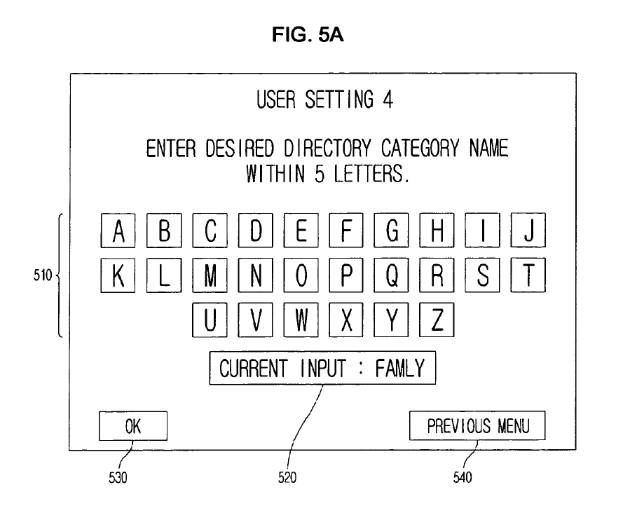

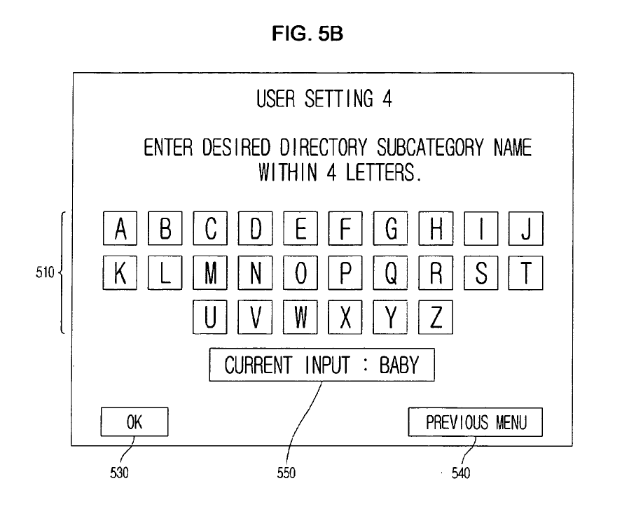

FIGS. 5A and 5B illustrate user interface screens for inputting a category according to an exemplary embodiment of the present general inventive concept. As illustrated in FIG. 5A, an expression prompting the user to enter a desired directory category name can be displayed at an upper portion of a screen (such as display unit 104), and, for example, letter keys of “A” to “Z” 510 to be used to input the category name can be displayed on the screen under the expression. The user can touch the displayed letter keys 510 to select desired Roman letters. Letter keys 510 can also be selected, for example, by buttons or a scroll wheel of input unit 140a. The Roman letters selected by the user can be displayed in a “current input” window 520 located at a lower portion of the screen. The user may be prompted to enter a desired category name. The number of characters may be limited, for example, to five characters, but this is not intended as a limitation, and any number of characters may be used. For example, if the user sequentially selects the letters F, A, M, L, and Y from the letter keys 510 to input “FAMLY” as a directory category, the letters F, A, M, L, and Y can be sequentially displayed in the input window 520. This allows the user to check whether or not they are correctly inputting a desired category name and to have a chance to correct a wrongly input name. When the input of the category name is completed, the user can select an “OK” key 530 to confirm the input category name, and then can select a “Previous Menu” key 540 to return to the previous menu.

When the user selects the “OK” key 520 upon completion of the input of the file category name on the screen of FIG. 5A, the user interface screen can be switched to that illustrated in FIG. 5B. As illustrated in FIG. 5B, an expression prompting the user to enter a desired file subcategory name can be displayed at an upper portion of the screen and letter keys of “A” to “Z” 510 to be used to input the category name can be displayed on the screen under the expression. The user can touch the letter keys or can use other input means as described above regarding FIG. 5A to select desired Roman letters. The Roman letters selected by the user can be displayed in a “current input” window 550 located at a lower portion of the screen. For example, when the user sequentially selects the letters B, A, B, and Y from the letter keys to input “BABY” as a file subcategory, the letters B, A, B, and Y can be sequentially displayed in the window. This allows the user to check whether or not they are correctly inputting a desired category name and to have a chance to correct a wrongly input name. When the input of the subcategory name is completed, the user can select an “OK” key to confirm the input subcategory, and then can select a “Previous Menu” key to return to the previous menu.

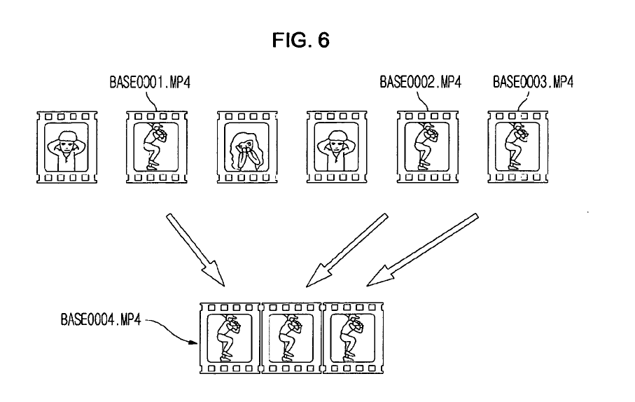

The selection (or input) of respective categories of a directory and a file assigns the unique selected (or input) categories respectively to corresponding directory and file names. Thus, desired images among stored images can be easily located, reproduced, deleted, and processed through categories assigned to file names of the desired images. FIG. 6 illustrates the concept that specific images can be selected through selection of a category according to an exemplary embodiment of the present general inventive concept. As illustrated in FIG. 6, when the user selects (or inputs) “sports” as a category and issues a command to generate and reproduce a new image combining selected images, the controller 202 can select, for example, files BASE0001.MP4, BASE0002.MP4, and BASE0003.MP4 having a category of “sports” from among files stored in the storage unit 106 and can combine the selected files to generate a new image file BASE0004.MP4. The controller 202 can playback the new image file on the display unit 104 if it is a moving image, and can display the new image file on the display unit 104 as a slide show if it is a still image. The user interface illustrated in FIGS. 5A and 5B may also be applied to implement a user interface used to select files corresponding to a category desired by the user.

In another exemplary embodiment of the present general inventive concept, without depending on selection (or input) of the user, the controller 202 of the camcorder 100 can determine a file name of an image by extracting a category characterizing the image from the image using an image category extraction algorithm provided in the controller 202 and then reflecting the extracted category in the file name, thereby enabling classification of images according to file names of the images.

For example, when an image of a portrait is obtained, the controller 202 can determine that the image is an image of a portrait from data such as positions and sizes of human-specific features in the image, and can set a category of the image to “portrait”. More specifically, in the case of subjects (for example family members), photographs of which are usually taken at a relatively high frequency, images of the family members may be previously captured and analyzed to extract categories of the images. Thereafter, when images of the family members are obtained, categories of the family members can be reflected in corresponding file names so that the images of the family members are automatically classified. In the case of a scenery image, scenery-specific features such as a skyline or a horizon can be extracted from the image and a category of the image can be set to “scenery” based on the scenery-specific features. In the case of sports games, the number of players and the positions of players of each sports game are unique. Individual-sports games also have unique motions. Thus, when a sports image is obtained, such unique features can be extracted from the image to determine that the image is a sports image and a category of the image can be set to “sports”. A game corresponding to the image can also be identified from the extracted features and the identified game can be set as a subcategory of the image.

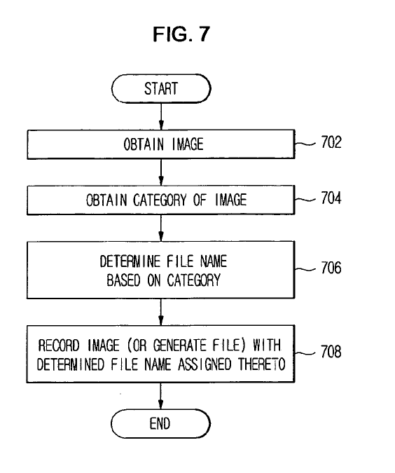

FIG. 7 illustrates a method of controlling an imaging apparatus according to an exemplary embodiment of the present general inventive concept. As illustrated in FIG. 7, the controller 202 obtains an image by processing an electrical signal of the image received through the optical unit 102 and the image capture element 204 (operation 702). The controller 202 obtains a category of the image before recording the image (operation 704) and determines a file name of the image based on the category (operation 706). Selection (or input) of the category by the user can be performed in the manner as described above with reference to FIGS. 4 and 5. When the file name is determined, the controller 202 records the image in a file format assigned according to the determined file name (operation 708). Recording images with file names, in which respective categories of the images are reflected, in this manner enables more convenient search and selective deletion/playback/processing of the images.

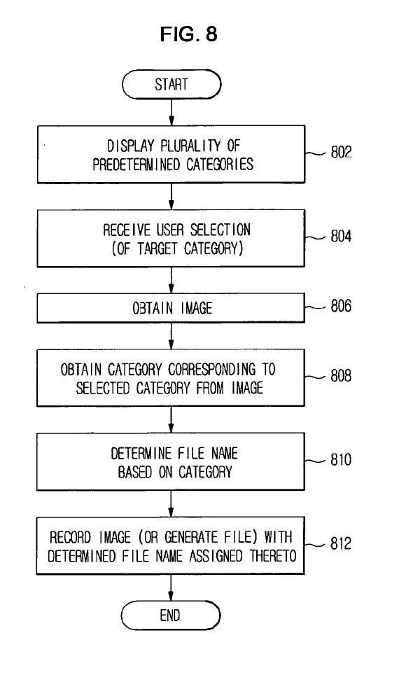

FIG. 8 illustrates a method of controlling an imaging apparatus according to another exemplary embodiment of the present general inventive concept. According to the method of controlling an imaging apparatus illustrated in FIG. 8, the user can select a category before obtaining an image. As illustrated in FIG. 8, the controller 202 displays a plurality of predetermined categories on the display unit 104 of the camcorder 100 (operation 802). When the user selects a desired category from among the plurality of predetermined categories displayed on the display unit 104, the controller 202 receives and stores the selected category to prepare for determination of a file name of an image to be recorded at a later time (operation 804). When a command to start capturing an image is issued, the controller 202 obtains an image by processing an electrical signal of the image received through the optical unit 102 and the image capture element 204 (operation 806). The controller 202 obtains a category of the image before recording the image (operation 808) and determines a file name of the image based on the category (operation 810). Selection (or input) of the category by the user can be performed in the manner as described above with reference to FIGS. 4 and 5. When the file name is determined, the controller 202 records the image in a file format assigned according to the determined file name (operation 812). Recording images with file names, in which respective categories directly selected by the user are reflected, in this manner enables more convenient setting of categories of images.

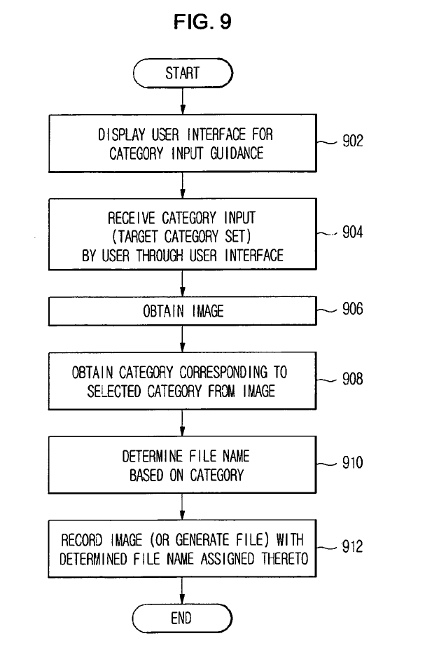

FIG. 9 illustrates a method of controlling an imaging apparatus according to another exemplary embodiment of the present general inventive concept. According to the method of controlling an imaging apparatus illustrated in FIG. 9, the user can input a category before obtaining an image. As illustrated in FIG. 9, the controller 202 displays a user interface to provide category input guidance on the display unit 104 of the camcorder 100 (operation 902). When the user inputs a desired category according to the category input guidance displayed on the display unit 104, the controller 202 receives and stores the input category to prepare for determination of a file name of an image to be recorded at a later time (operation 904). When a command to start capturing an image is issued, the controller 202 obtains an image by processing an electrical signal of the image received through the optical unit 102 and the image capture element 204 (operation 906). The controller 202 obtains a category of the image before recording the image (operation 908) and determines a file name of the image based on the category (operation 910). Selection (or input) of the category by the user can be performed in the manner as described above with reference to FIGS. 4 and 5. When the file name is determined, the controller 202 records the image in a file format assigned according to the determined file name (operation 912). Recording images with file names, in which respective categories directly input by the user are reflected, in this manner enables a wider variety of categories to be set.

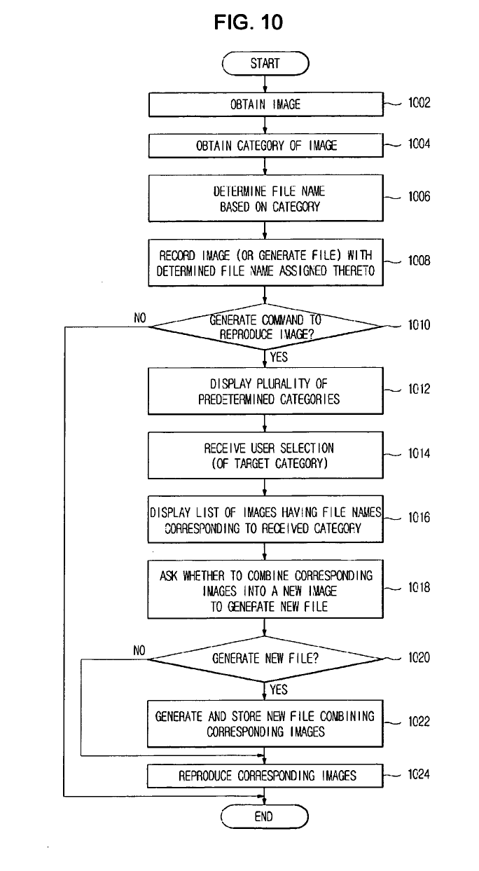

FIG. 10 illustrates a method of controlling an imaging apparatus according to another exemplary embodiment of the present general inventive concept. As illustrated in FIG. 10, when a command to start capturing an image is issued, the controller 202 obtains an image by processing an electrical signal of the image received through the optical unit 102 and the image capture element 204 (operation 1002). The controller 202 obtains a category of the image before recording the image (operation 1004) and determines a file name of the image based on the category (operation 1006). Selection (or input) of the category by the user can be performed in the manner as described above with reference to FIGS. 4 and 5. When the file name is determined, the controller 202 records the image in a file format assigned according to the determined file name (operation 1008).

When a command to reproduce images recorded in this manner is issued (“YES” in operation 1010), the controller 202 displays a plurality of predetermined categories on the display unit 104 of the camcorder 100 (1012). If a command to reproduce images is not issued (“NO” in operation 1010) the method may end. When the user selects a desired category from among a plurality of categories displayed on the display unit 104, the controller 202 receives the selected category to use it in selecting recorded images (operation 1014). The controller 202 displays a list of images having file names corresponding to the received category on the display unit 104 (operation 1016). The controller 202 then displays a message prompting the user to decide whether or not to combine the images of the list to generate a new file on the display unit 104 (operation 1018). If the user issues a command to generate a new file in response to the prompt message (“YES” in operation 1020), the controller 202 generates and stores a new file combining the images (operation 1022) and reproduces a corresponding image (operation 1024). A file name of the newly generated file, for example, can have characters indicating the same category as that applied to the source files and can have a new serial number. If the user decides not to generate a new file while the list of images having file names corresponding to the received category is displayed on the display unit 104 (“NO” in operation 1020), the controller 202 does not generate a new file and reproduces the selected images (operation 1024). At any operation indicated above, a user may cancel an operation, or may return to a previous operation to change a selection or to correct an error.

As described above, the controller 202 may generate the user interface for selection of categories between when the image is captured when it is stored. In this case, the image can be temporarily stored with a temporary file name in a memory until the category is selected and the file name is assigned, and then the image can be stored with the assigned file name after selection of the categories.

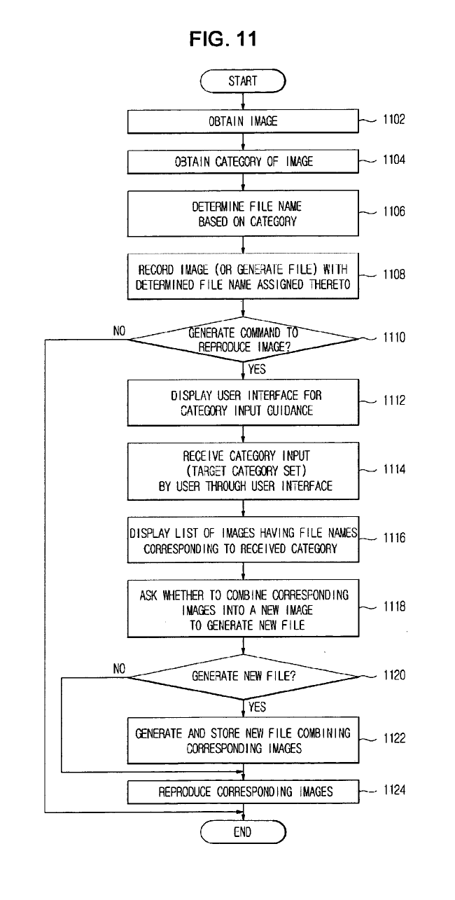

FIG. 11 illustrates a method of controlling an imaging apparatus according to another exemplary embodiment of the present general inventive concept. As illustrated in FIG. 11, when a command to start capturing an image is issued, the controller 202 obtains an image by processing an electrical signal of the image received through the optical unit 102 and the image capture element 204 (operation 1102). The controller 202 obtains a category of the image before recording the image (operation 1104) and determines a file name of the image based on the category (operation 1106). Selection (or input) of the category by the user can be performed in the manner as described above with reference to FIGS. 4 and 5. When the file name is determined, the controller 202 records the image in a file format assigned according to the determined file name (operation 1108).

When a command to reproduce images recorded in this manner is issued (“YES” in operation 1110), the controller 202 displays a user interface to provide category input guidance on the display unit 104 of the camcorder 100 (operation 1112). When the user inputs a desired category according to the category input guidance displayed on the display unit 104, the controller 202 receives the input category to use it in selecting recorded images (operation 1114). The controller 202 displays a list of images having file names corresponding to the received category on the display unit 104 (operation 1116). The controller 202 then displays a message prompting the user to decide whether or not to combine the images of the list to generate a new file on the display unit 104 (operation 1118). If the user issues a command to generate a new file in response to the prompt message (“YES” in operation 1120), the controller 202 generates and stores a new file combining the images (operation 1122) and reproduces a corresponding image (operation 1124). A user may choose to combine all of the images of the list, or a user may choose to combine selected images of the listed images. A file name of the newly generated file can have, for example, characters indicating the same category as that applied to the source files and a new serial number. If the user decides not to generate a new file while the list of images having file names corresponding to the received category is displayed on the display unit 104 (“NO” in operation 1120), the controller 202 does not generate a new file and reproduces the selected images (operation 1124).

The present general inventive concept can also be embodied as computer-readable codes on a computer-readable medium. The computer-readable medium can include a computer-readable recording medium and a computer-readable transmission medium. The computer-readable recording medium is any data storage device that can store data which an be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in distributed fashion. The computer-readable transmission medium can transmit carrier waves and signals (e.g., wired or wireless data transmission through the Internet). Also, functional programs, codes, and code segments to accomplish the present general inventive concept can be easily construed by programmers skilled in the art to which the present general inventive concept pertains.

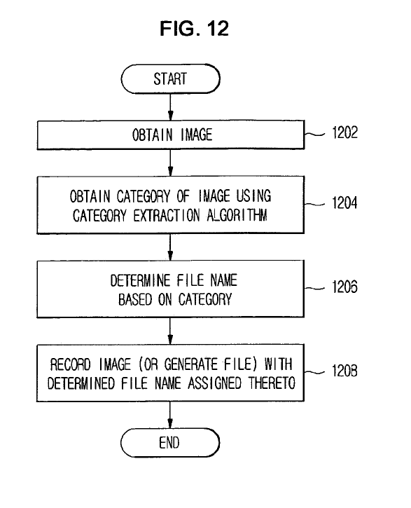

FIG. 12 illustrates a method of controlling an imaging apparatus according to another exemplary embodiment of the present general inventive concept. As illustrated in FIG. 12, the controller 202 obtains an image by processing an electrical signal of the image received through the optical unit 102 and the image capture element 204 (operation 1202). The controller 202 obtains a category of the image using an image category extraction algorithm before recording the image (operation 1204) and determines a file name of the image based on the category (operation 1206). When the file name is determined, the controller 202 records the image in a file format assigned according to the determined file name (operation 1208). In an exemplary embodiment, a category is automatically extracted from an image using the image category extraction algorithm and the image is then recorded with a file name, in which the automatically extracted category of the image is reflected, thereby enabling more convenient assignment of respective categories to images. In addition, if the automatic image category extraction method using the category extraction algorithm is applied to the operation to obtain a category of an image in FIGS. 10 and 11 described above, more various methods to control an imaging apparatus can be achieved.

As is apparent from the above description, in the imaging apparatus and the method to control the same according to the present general inventive concept, when a captured image is recorded (or stored), a category of the image can be obtained according to a feature of the image, and a file of the image which can be assigned a file name determined based on the category can be created and stored, thereby enabling more convenient classification of a large number of images.

Although several exemplary embodiments of the present general inventive concept have been illustrated and described, it will be appreciated by those skilled in the art that changes may be made in these exemplary embodiments without departing from the principles and spirit of the general inventive concept, the scope of which is defined in the claims and their equivalents.

What is claimed is:

1. A method of controlling an imaging apparatus, the method comprising:
obtaining an image; and
recording the image and assigning a file name determined based on a category of the image.

2. The method of claim 1, further comprising:
generating, when the image is recorded, a directory assigned a directory name determined based on the category of the image; and
recording a file of the image in the directory.

3. The method of claim 2, wherein the file name and the directory name are determined to be associated with each other through the category.

4. The method of claim 1, further comprising:
receiving a category,
wherein the recording the image and assigning a file name is determined based on the received category.

5. The method of claim 4, wherein the category is obtained by selecting at least one category corresponding to the image from among a plurality of preset categories.

6. The method of claim 4, wherein the category is obtained by arbitrarily determining a category based on a feature of the image so that the determined category represents the image.

7. The method of claim 4, wherein the category is obtained by extracting a feature of the image using a predetermined algorithm and selecting at least one category corresponding to the extracted feature from among a plurality of preset categories.

8. The method of claim 4, wherein receiving the category includes displaying a user interface to provide guidance for selection of the category and allowing a user to select the category as a target category through the user interface.

9. The method of claim 1, further comprising:
selecting and reproducing, when a command to reproduce files corresponding to a target category is issued, images assigned a file name corresponding to the target category from among recorded images.

10. The method of claim 9, wherein the target category is determined by selecting at least one category corresponding to the image from among a plurality of preset categories.

11. The method of claim 9, wherein the target category is obtained by determining a target category based on a feature of the image so that the determined target category represents the image.

12. The method of claim 9, further comprising:
displaying a user interface to provide guidance for selection of the target category; and
receiving selection of the target category through the user interface.

13. An imaging apparatus comprising:
an imaging unit to obtain an image;
a storage unit to record the image; and
a controller to record the image and to assign a file name determined based on a category of the image in the storage unit.

14. The imaging apparatus of claim 13, wherein the controller performs a control operation to generate a directory whose name is determined based on the category of the image and to record a file of the image in the generated directory.

15. The imaging apparatus of claim 13, wherein the controller determines the file name and the directory name to be associated with each other through the category.

16. The imaging apparatus of claim 13, further comprising:
an input unit to input a category,
wherein the controller receives the category input through the input unit.

17. The imaging apparatus of claim 16, wherein the input unit is a user interface displayed to provide guidance for selection of the category.

18. The imaging apparatus of claim 17, further comprising a display unit,
wherein the user interface is displayed on the display unit.

19. A computer-readable medium having executable code stored thereon to perform a method of controlling an imaging apparatus, the method comprising:
obtaining an image; and
recording the image and assigning a file name determined based on a category of the image.

20. A method of controlling an imaging apparatus, the method comprising:
selecting a category;
capturing an image; and
assigning a file name of the selected category and recording the captured image according to the file name.

21. An imaging apparatus, comprising:
a memory unit;
an imaging unit to capture an image; and
a controller to select a category and assign a file name corresponding to the category, and to store the image in the memory unit according to the category.
